(19) United States
(12) Patent Application Publication
(10) Pub. No.: US 2009/0102864 A1
(43) Pub. Date: Apr. 23, 2009

(54) DRIVING METHOD FOR COLOR SEQUENTIAL DISPLAY

(75) Inventors: Kuan-Hsu Fan-Chiang, Tainan County (TW); Bing-Jei Liao, Tainan County (TW); Chung-Yuan Liu, Tainan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: HIMAX DISPLAY, INC., Tainan County (TW)

(21) Appl. No.: 11/875,949

(22) Filed: Oct. 21, 2007

(51) Int. Cl. G09G 5/10

(52) U.S. Cl. 345/690

(57) ABSTRACT

A driving method for color sequential display, for displaying a frame during a frame period, is provided. The frame period includes a plurality of sub-frame periods, and a compensation period is included between adjacent sub-frame periods. The driving method includes the following steps. During a plurality of sub-frame periods, a first color light, a second color light, and a third color light are used respectively as a light source of the color sequential display. A fourth color light is used as the light source of the color sequential display during a plurality of compensation periods.

### BACKGROUND OF THE INVENTION

1. Field of the Invention

The present invention relates to a method of driving a display. More particularly, the present invention relates to a driving method for a color sequential display.

2. Description of Related Art

In a conventional liquid crystal display (LCD), a light source of a backlight module is usually designed to be a white light source (generally a cold cathode tube is used to emit the white light source). The white light source forms the backlight source required by each pixel through a color filter. According to a pixel array, red (R), green (G), and blue (B) color filters are disposed on one pixel position. The method consumes cost, and the color mixing problem exists at the adjacent positions among the red (R), green (G), and blue (B) color filters. In addition, as the LCD adopts the architecture of the color filter, so the white light source is blocked by the color filter, and the luminance of the LCD is reduced.

Based on the above problem, a color sequential display with a color sequential method and a control circuit is developed. The color sequential display uses light-emitting diodes (LED) of various colors to replace the conventional white light backlight source, and one color light source is lightened alternatively in time sequence to display the color of each pixel. The conventional driving technology of the LCD uses the color filter to perform spatial color mixture and the color sequential display uses the temporal color mixture of different color light sources. The principle is that in the time period of visual persistence of human eyes, red (R), green (G), and blue (B) images are quickly switched on a time axis, thereby generating the color mixture effect.

Therefore, the display does not require the color filter, so the light source is not blocked, and the luminance of the picture of the display is improved. In addition, the color sequential display uses the LED as the light source of the display, and the color display technology of the color sequential method is used together, such that the specification of the color sequential display becomes light, thin, short, and small, and a higher spatial resolution is obtained with lower cost. Although the color sequential display has advantages, such as high luminance, high resolution, high chroma, and light, thin, short, and small, the display still has other problems to be overcome, for example, color break up (CBU).

CBU is a color separation phenomenon at the object edge generated by the instinct of the human eyes of random saccade or pursuit of the object in the picture, which makes the objects in the picture not falling on a same point on the retina in visual because of the color fields of various colors. FIG. 1 is a schematic view of the generation of the CBU. Referring to FIG. 1, in the conventional driving technology, a full-color picture is divided into red (R), green (G), and blue (B) sub-pictures, and the red (R), green (G), and blue (B) sub-pictures are quickly and sequentially displayed, so as to finish the display of a full-color picture. Here, the display of a white (W) image is set as an example. When it is required to display a white image, observing the white image 100 from a moving observation point, the left edge is blue (B) and blue plus green (B+G) color combination respectively, and the right edge is red (R) and red plus green (R+G) color combination respectively, which are not white (W) required to be displayed.

Although recently several methods, for example, picture motion compensation technology and picture black insert method, are developed to solve the CBU phenomenon, the effect is limited, so it is an inevitable topic to be discussed and researched when manufacturers researches and develops the products.

### SUMMARY OF THE INVENTION

Accordingly, the present invention is directed to providing a driving method for a color sequential display, capable of greatly improving the luminance of the color sequential display, and effectively alleviating the effect of CBU.

As embodied and broadly described herein, the present invention provides a driving method for a color sequential display, for displaying a picture in a frame period. The frame period includes a plurality of sub-frame periods, and a compensation period is further included between the adjacent sub-frame periods. The driving method including the following steps. In a plurality of sub-frame periods, a first color light, a second color light, and a third color light are respectively used as a light source of the color sequential display. During each compensation period, a fourth color light is used as the light source of the color sequential display.

In an embodiment of the present invention, the first color light, the second color light, and the third color light are a red light, a green light, and a blue light, and the fourth color light is a white light.

In an embodiment of the present invention, the driving method further includes displaying a picture according to a first color signal, a second color signal, and a third-color signal. The first color signal, the second color signal, and the third color signal are generated according to a first grayscale data, a second grayscale data, and a third grayscale data.

In an embodiment of the present invention, the driving method further includes displaying a picture according to the first color signal, the second color signal, and the third color signal, and the first color signal, the second color signal, and the third color signal are generated according to the sub-frame period, the compensation period, the first grayscale data, the second grayscale data, and the third grayscale data.

In an embodiment of the present invention, the driving method further includes displaying a frame according to a fourth color signal, and the fourth color signal is generated according to a minimum grayscale value of the first grayscale data, the second grayscale data, and the third grayscale data.

In an embodiment of the present invention, when the color sequential display displays the first color signal, the second color signal, the third color signal, and the fourth color signal, the first color light, the second color light, the third color light, and the fourth color light are used as the light source of the color sequential display.

In the present invention, the method of inserting a white picture in a frame period is adopted, such that a picture is obtained by mixing in a color sequence of red, white, green, white, blue, and white, thereby greatly improving the luminance of the color sequential display. In addition, the white picture is inserted to separate red, green, and blue pictures, so the influence of the CBU can be effectively reduced.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of the generation of the CBU.

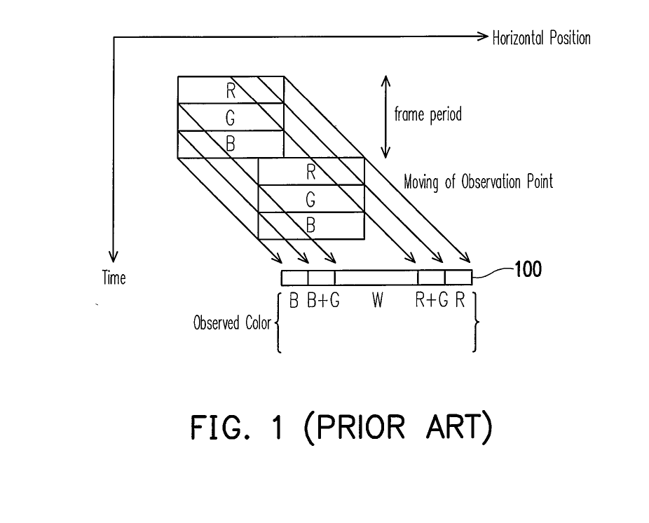

FIG. 2 is a flow chart of a driving method for a color sequential display according to an embodiment of the present invention.

FIG. 3 is a timing chart of a driving method for a color sequential display according to an embodiment of the present invention.

### DESCRIPTION OF EMBODIMENTS

Before the spirit of the present invention is illustrated by the embodiments, firstly it is assumed that the display using the method of the present invention is a color sequential display, and a dynamic image is displayed at an updating rate of 60 pictures per second to display pictures. In addition, it is assumed that the color sequential display uses the LED as the light source, and the colors of the LED that used as the light source can be red (R), green (G), and blue (B).

Under the above assumption, when the color sequential display displays a full-color picture, it is necessary to sequentially transmit the red (R), green (G), and blue (B) display data to a display panel within 1/60 seconds, and use the red light, the green light, and the blue light as the light source of the color sequential display correspondingly. Here, the time of displaying a full-color picture is referred to as a frame period.

Although under the above assumption, those of ordinary skill in the art should know that when the updating rate varies, the so-called frame period may also vary accordingly. In addition, the light source in addition to the LED can also use a white light source in conjunction with a color wheel. It is unknown whether other technologies that can be used as light sources are developed in the future, so the present invention is not limited to the LED.

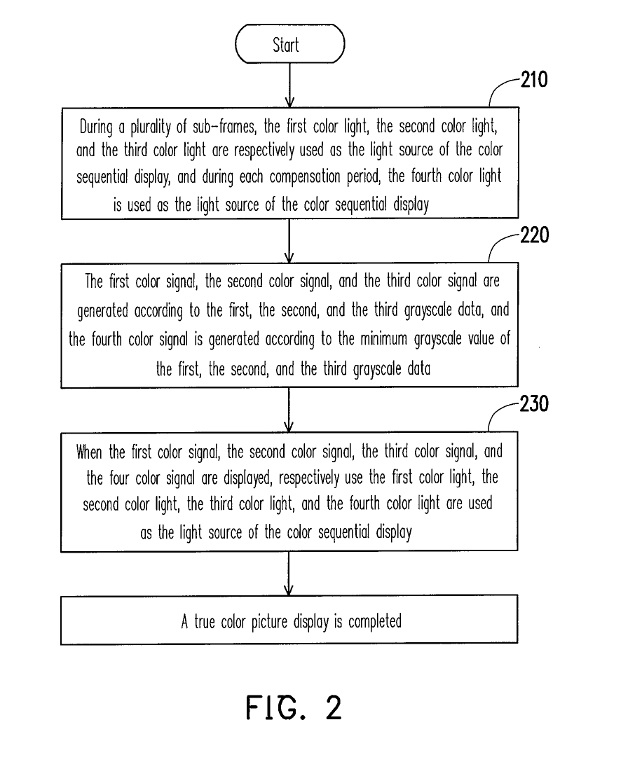

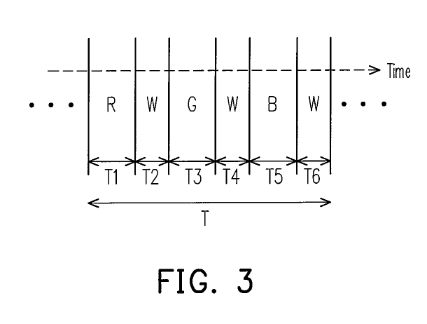

FIG. 2 is a flow chart of a driving method for a color sequential display according to an embodiment of the present invention. FIG. 3 is a timing chart of a driving method for a color sequential display according to an embodiment of the present invention. In FIG. 3, on the time axis, the frame period T includes sub-frame periods T1, T3, and T5, and the adjacent sub-frame periods further include a compensation period. For example, the sub-frame periods T1 and T3 have a compensation period T2, the sub-frame periods T3 and T5 have a compensation period T4, and the sub-frame period T5 and the next frame period (not shown) have a compensation period T6. The sub-frame periods T1, T3, and T5 are greater than the compensation periods T2, T4, and T6 in terms of time. In this embodiment, the color sequential display displays the red (R), green (G), and blue (B) pictures respectively in the sub-frame periods T1, T3, and T5, and displays the white (W) picture in the compensation periods T2, T4, and T6.

Herein, the spirit of the present invention is illustrated with reference to FIGS. 2 and 3. Firstly, during the sub-frame period T1, the first color light is used as the light source of the color sequential display. During the sub-frame periods T3 and T5, the second color light and the third color light are respectively used as the light source of the color sequential display. During the compensation periods T2, T4, and T6, the fourth color light is used as the light source of the color sequential display (step 210). The first color light, the second color light, and the third color light are respectively red light, green light, and blue light generated by red (R), green (G), and blue (B) LEDs, and the fourth color light is for example a white light formed by mixing the red light, the green light, and the blue light.

Those of ordinary skill in the art should know that in order to display a full-color picture, it is necessary for the color sequential display to transmit the red (R), green (G), and blue (B) grayscale data to the display region of the color sequential display, and use the red, green, and blue backlight to display a full-color picture. As shown in FIG. 3, the driving method for the color sequential display of the embodiment of the present invention involves inserting the white picture in the red (R), green (G), and blue (B) color mixing process, thereby improving the luminance and alleviating the CBU. However, the method of inserting the white picture may reduce the color saturation of the picture.

Therefore, it is assumed in this embodiment that the first, the second, and the third grayscale data for driving the display region of the color sequential display are respectively red (R), green (G), and blue (B) grayscale data. Next, according to the first, the second, and the third grayscale data, a first color signal, a second color signal, and a third color signal are generated, so as to respectively drive the display region of the color sequential display in the corresponding sub-frame periods T1, T3, and T5. The color sequential display further generates a fourth color signal according to the first grayscale data, the second grayscale data, and the third grayscale data, so as to drive the display region of the color sequential display (step 220), in which the fourth color signal is a white (W) color signal. The color sequential display further generates the first, the second, and the third color signals according to the fourth color signal, so as to compensate the color saturation of the picture. Therefore, the generated first color signal, the second color signal, the third color signal, and the fourth color signal are used to perform color mixing, thus preventing the color saturation of the picture from being reduced.

It should be noted that the first color signal, the second color signal, the third color signal, and the fourth color signal can be generated through an algorithm operation. That is, an algorithm is used to operate the first grayscale data, the second grayscale data, and the third grayscale data, so as to generate the first color signal, the second color signal, the third color signal, and the fourth color signal. Herein, an algorithm is set as an example to illustrate the generating method of the first, the second, the third, and the fourth color signals. An embodiment of an algorithm used in the driving method for the color sequential display of the display is described as follows. Here, it is assumed that the time of the sub-frame periods T1, T3, and T5 are t1, and the time of the compensation periods T2, T4, and T6 are t2;

W=min(R,G,B);

R′=(R*t1−k*W*t2)/t1;

G′=(G*t1−k*W*t2)/t1;

B′=(B*t1−k*W*t2)/t1;

where R′, G′, and B′ are the first, the second, and the third color signals respectively, W is the fourth color signal, and R, G, B are the first, the second, and the third grayscale data respectively. k is a coefficient, which is provided for the user to adjust the values of R′, G′, and B′ according to requirements.

It is known from the above algorithm that the fourth color signal W is generated according to the minimum value of the first, the second, and the third grayscale data R, G, B, and the first, the second, and the third color signals R′, G′, and B′ are generated according to the time t1 of the sub-frame period, the time t2 of the compensation period, and the first, the second, and the third grayscale data R, G, B. However, the algorithm used by the embodiment of the present invention is not limited to the above. The time of the sub-frame periods T1, T3 and T5 can be different, and the time of the compensation periods T2, T4, and T6 can also be different. The algorithm used in the embodiment of the present invention can also generate the first color signal, the second color signal, the third color signal, and the fourth color signal according to the sub-frame periods T1, T3, and T5 and the compensation periods T2, T4, and T6. In other words, the algorithm can adjust the parameters according to the requirements of the user, so as to generate the picture chroma required by the user.

After the first, the second, the third, and the fourth color signals are generated, according to the timing chart as shown in FIG. 3, during the sub-frame periods T1, T3, and T5, the first color signal, the second color signal, and the third color signal are transmitted to the display region of the color sequential display, and during the compensation periods T2, T4, and T6, the fourth color signal is transmitted to the display region of the display. When the display region of the color sequential display displays the picture of the first color signal, the second color signal, the third color signal, and the fourth color signal, the first color light, the second color light, the third color light, and the fourth color light are respectively used as the light source of the display (step 230). Finally, according to the display of the first color signal, the second color signal, the third color signal, and the fourth color signal, the color sequential display exhibits a full-color picture having high luminance and high chroma.

It should be noted that the colors represented by the first color light, the second color light, the third color light, the first grayscale data, the second grayscale data, the third grayscale data, the first color signal, the second color signal, and the third color signal are not limited to the above sequence (red (R)→green (G)→blue (B)).

To sum up, in the embodiment of the present invention, the white picture is inserted in the process of color mixing of red, green, and blue pictures, for example, a sequence of red→white→green→white→blue→white, thereby greatly improving the luminance of the color sequential display. Further, the operation using the algorithm is used to generate the color signals, thus preventing reducing the color saturation of the picture. In addition, the inserted white picture separates the red, the green, and the blue pictures, thus alleviating the effect of color separation and effectively alleviating the CBU effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving method for a color sequential display, for displaying a picture during a frame period, wherein the frame period comprises a plurality of sub-frame periods, and a compensation period is further included between adjacent sub-frame periods in the frame period, and the method comprising:
respectively using a first color light, a second color light, and a third color light as a light source of the color sequential display during the sub-frame periods, wherein in each compensation period, a fourth color light is used as the light source of the color sequential display.

2. The driving method for a color sequential display as claimed in claim 1, wherein the first color light, the second color light, and the third color light are a red light, a green light, and a blue light.

3. The driving method for a color sequential display as claimed in claim 1, wherein the fourth color light is a white light.

4. The driving method for a color sequential display as claimed in claim 1, wherein the sub-frame period is greater than the compensation period.

5. The driving method for a color sequential display as claimed in claim 1, further comprising displaying the picture according to a first color signal, a second color signal, and a third color signal.

6. The driving method for a color sequential display as claimed in claim 5, further comprising generating the first color signal, the second color signal, and the third color signal according to a first grayscale data, a second grayscale data, and a third grayscale data.

7. The driving method for a color sequential display as claimed in claim 5, further comprising generating the first color signal, the second color signal, and the third color signal according to the sub-frame period, the compensation period, the first grayscale data, the second grayscale data, and the third grayscale data.

8. The driving method for a color sequential display as claimed in claim 6, wherein the picture is further displayed according to a fourth color signal, and the fourth color signal is generated according to a minimum grayscale value of the first grayscale data, the second grayscale data, and the third grayscale data.

9. The driving method for a color sequential display as claimed in claim 8, wherein when the first color signal, the second color signal, the third color signal, and the fourth color signal are displayed, the first color light, the second color light, the third color light, and the fourth color light are used as the light source of the color sequential display.
